(19) United States
(12) Patent Application Publication
(10) Pub. No.: US 2004/0081889 A1
(43) Pub. Date: Apr. 29, 2004

(54) Negative electrode for lithium secondary battery and lithium secondary battery comprising same

(75) Inventors: Jea-Woan Lee, Suwon-City (KR); Chung-Kun Cho, Suwon-City (KR)

Correspondence Address: STAAS & HALSEY LLP, SUITE 700, 1201 NEW YORK AVENUE, N.W., WASHINGTON, DC, 20005, US

(73) Assignee: SAMSUNG SDI CO,, LTD, Suwon-City (KR)

(21) Appl. No.: 10/603,777

(22) Filed: Jun. 26, 2003

(30) Foreign Application Priority Data
Oct. 25, 2002 (KR) 2002-65483

(51) Int. Cl. H01M 4/64; H01M 4/60; H01M 4/58; H01M 4/48

(52) U.S. Cl. 429/233; 429/245; 429/231.95; 429/231.1; 429/218.1; 429/213

(57) ABSTRACT

A negative electrode for a lithium secondary battery includes a substrate having a mean roughness of 30 to 4000 Å and a lithium layer coated on the substrate, and a lithium secondary battery includes the negative electrode. The obtained lithium secondary battery has improved cycle-life characteristics.

### CROSS-REFERENCE TO RELATED APPLICATION

This application claims the benefit of Korean Application No. 2002-65483, filed Oct. 25, 2002, in the Korean Intellectual Property Office, the disclosure of which is incorporated herein by reference.

### BACKGROUND OF THE INVENTION

1. Field of the Invention

The present invention relates to a negative electrode for a lithium secondary battery and a lithium secondary battery comprising the same, and more particularly, to a negative electrode for the lithium secondary battery having improved cycle-life characteristics and a lithium secondary battery comprising the same.

2. Description of the Related Art

The use of portable electronic instruments is increasing as electronic equipment gets smaller and lighter due to developments in high-tech electronic industries. Studies on secondary batteries are actively being pursued in accordance with the increased need for a battery having a high energy density for use as a power source in these portable electronic instruments. Batteries generate energy through an electrochemical reaction between positive and negative electrodes. Accordingly, in order to improve the performance and safety characteristics in batteries, such as cycle-life characteristics, capacity, and power, the electrochemical characteristics of active materials participating in the electrochemical reaction require improvement. Accordingly, studies on improving the electrochemical characteristics of negative and positive active materials are ongoing.

Lithium is promising to provide a high capacity battery due to the high electric capacity per unit weight thereof, and to provide a high voltage due to its high electro negativity. Further, in the case of employing a lithium metal as a negative active material, the lithium metal can serve both as an active material and a current collector. A metallic lithium plate can therefore be used for a negative electrode plate as is, without requiring an additional current collector. In addition, the negative electrode plate may be prepared by depositing lithium on a metal foil in a certain thickness or by compressing a lithium foil onto a metal foil or exmet (expanded metal) sheet, or may also be prepared by depositing a metal on a polymer film and subsequently attaching a lithium foil thereto or depositing a lithium metal thereon.

However, lithium metal lacks safety and tends to undergo a side reaction with an electrolyte and generate dendrites. In addition, in order to prolong battery cycle-life, an excessive amount of lithium is required that is 4 or 5 times that of an amount of positive active material utilized. Further, for a negative electrode plate fabricated by deposition or compression techniques, the electrochemically reactive lithium is present on the outermost surface thereof. In this case, when the surface is rough, a substantial number of dendrites are generated so that the amount of electrochemically inactive lithium is disadvantageously increased.

Further, when the lithium is deposited on a substrate, the mean surface roughness (Ra) of deposited lithium is affected by the mean surface roughness of the substrate. Therefore, an electrode having lithium deposited on a substrate with a rough surface is inferior to an electrode with lithium deposited on a smooth surface in terms of cycle-life characteristics of a battery since the lithium ions tend to be concentrated on pinnacles on the surface due to movement of the lithium ions during charge and discharge. Thus, dendrites of lithium are excessively generated. As a result, many lithium ions can no longer participate in the electrochemical reaction, resulting in deterioration of the cycle-life of the battery.

Accordingly, the cycle-life characteristics may be improved by controlling the mean surface roughness of the substrate for a negative electrode to within a certain range.

### SUMMARY OF THE INVENTION

It is an aspect of the present invention to provide a negative electrode for a lithium secondary battery having improved cycle-life characteristics.

It is another aspect of the present invention to provide a lithium secondary battery comprising the negative electrode having improved cycle-life characteristics.

To achieve these aspects, the present invention provides a negative electrode for the lithium secondary battery comprising a substrate having a mean surface roughness of 30 to 4000 Å and a lithium layer coated on the substrate.

The present invention further provides a lithium secondary battery comprising the negative electrode.

Additional aspects and advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the preferred embodiments, taken in conjunction with the accompanying drawings of which:

FIG. 1 is a cross-sectional drawing illustrating a negative electrode according to an embodiment of the present invention.

FIG. 2 is a cross-sectional drawing illustrating a lithium secondary battery according to an embodiment of the present invention.

FIG. 3 is a graph showing cycle-life characteristics of test cells according to Example 3 and Comparative Example 2.

FIG. 4 is a graph showing cycle-life characteristics of test cells according to Examples 4-9 and Comparative Examples 3 and 4.

### DETAILED DESCRIPTION OF THE PREFERRED EMBODIMENTS

Reference will now be made in detail to the present preferred embodiments of the present invention, examples of which are illustrated in the accompanying drawings, wherein like reference numerals refer to the like elements throughout. The embodiments are described below in order to explain the present invention by referring to the figures.

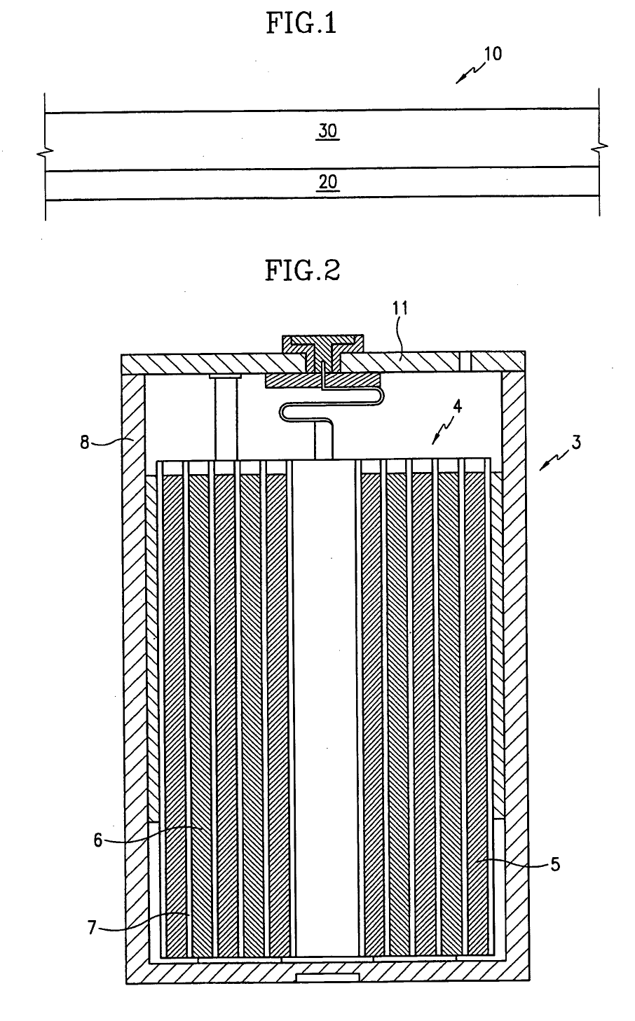

Hereinafter, the present invention is described with reference to the attached drawings in detail. According to the first embodiment, a negative electrode for the lithium secondary battery is provided. The negative electrode improves cycle-life characteristics of the lithium secondary battery. FIG. 1 shows a cross-sectional drawing of a negative electrode for a lithium secondary battery according to an embodiment of the present invention.

The negative electrode (10) for the lithium secondary battery is prepared by coating a lithium layer (30) on a substrate (20) having a mean surface roughness of 30 to 4000 Å. The substrate is also used as a negative electrode current collector. The mean surface roughness is preferably 30 to 3000 Å, more preferably 30 to 1500 Å, further more preferably 30 to 500 Å, and most preferably 30 to 100 Å. When the mean surface roughness is brought to less than 30 Å, time and effort are consumed so that the cost is increased. If the roughness is more than 4000 Å, lithium concentrates on the pinnacles of the negative electrode surface, generating lithium dendrites, and dead lithium which cannot participate in the electrochemical reaction increases, so that the cycle-life characteristics are deteriorated.

The substrate (20) of the negative electrode is preferably a conductive substrate since a conductive substrate offers a continuous electric network to provide an uninterrupted electron supply so that the amount of dead lithium is decreased.

Examples of a conductive substrate for a negative electrode may include a metal foil, a metal film, a conductive polymer film, a polymer film deposited with a metal, a polymer film incorporated with a conductive agent, and the like. The method to control the mean surface roughness of the negative electrode is determined according to the type of substrate. In the case of a metal substrate, a polishing technique is adopted, and in the case of a polymer film, a product having the above-ranged mean surface roughness is commercially available.

Metals suitable for being applied to the negative electrode in the form of a metal foil or a metal film may include copper or nickel. The conductive film may include polyacetylene, polypyrrole, polyaniline, polythiophene, poly(p-phenylene), poly(phenylene vinylene), polyazulene, polyperinaphthalene, polyacene, polynaphthalene-2,6-diyl, and the like. The polymer film deposited with the metal is a polymer film on which a metal such as copper or nickel is deposited. Since the polymer film deposited with the metal also significantly influences the mean surface roughness of the negative electrode substrate, the mean surface roughness of the polymer film is preferably controlled within the range equivalent to that of the negative electrode substrate. The polymer film incorporated with a conductive agent is a polymer film having a conductive agent dispersed therein. Representative examples of the conductive agent may include a conductive metal oxide such as tin oxide, tin phosphate (SnPO₄), titanium oxide, or a perovskite material (LaSrCoO₃, LaSrMnO₃), a metal such as tin, copper, or nickel, and a carbonaceous conductive material such as graphite or carbon black.

The polymer film used in fabricating the polymer film deposited with the metal or the polymer film incorporated with the conductive agent may include a polyester such as poly(ethylene terephthalate) (PET) and poly(butylene terephthalate) (PBT); a polyolefin such as polyethylene and polypropylene; a polyamide such as nylon; poly(vinylidene fluoride), poly(tetrafluoro ethylene), polystyrene, poly(acrylonitrile), poly(vinyl chloride); a polycarbonate; a polyacrylate such as poly(methyl methacrylate), and a copolymer or a mixture thereof, and preferably poly(ethylene terephthalate), polypropylene, polyethylene, or poly(vinyl chloride).

In the case of a metal foil or a metal film, the mean surface roughness of the negative electrode substrate may be controlled by compressing or polishing the metal foil or metal film, while in the case of a polymer film, the mean roughness may be controlled by coating the polymer film or by purchasing a polymer film having the desired mean surface roughness.

When a negative electrode is used in which lithium metal is coated on the substrate having the desired mean roughness, it is not likely that lithium ions will concentrate on the pinnacles of the electrode surface. Thus, the formation of dendrites is prevented, and the amount of dead lithium is decreased, improving the cycle-life characteristics of a lithium secondary battery.

When a metallic lithium negative electrode having a thickness of 50 μm or less is used, the substrate supporting the electrode is preferably a substrate having a mean surface roughness controlled within the desired range. The method for applying the lithium layer (30) to the substrate (20) may include depositing the lithium on the substrate or compressing a lithium foil on the substrate. Preferably, a deposition technique is used. Most preferably, it is a deposition technique using a Tungsten boat or a Molybdenum boat. The deposition pressure is preferably controlled to be in a range between 5.0×10⁻⁷ and 5.0×10⁻⁶ torr.

The metallic lithium negative electrode may be used for a negative electrode for the lithium secondary battery. Lithium secondary batteries are classified as a lithium ion battery, a lithium ion polymer battery, or a lithium polymer battery, depending on the kinds of separator and electrolyte. The batteries are further classified as a cylindrical type, a prismatic type, a coin type, a pouch type, and the like, depending on the shape. In addition, the battery may be divided into a bulk type and a thin film type, depending on the size. The individual structures and fabrication methods thereof are known in the art. Among them, the structure of a prismatic-type battery is shown in FIG. 2. The lithium ion prismatic battery (3) is assembled by inserting an electrode assembly (4) into a casing (8), injecting an electrolyte into the upper part of the casing (8), and sealing the casing (8) with a cap plate (11). The electrode assembly (4) comprises a positive electrode (5), a negative electrode (6), and a separator (7) interposed between the positive electrode (5) and the negative electrode (6).

The second embodiment according to the present invention provides a lithium secondary battery comprising the negative electrode according to the first embodiment. The lithium secondary battery comprises a negative electrode comprising a substrate having a mean surface roughness of 30 to 4000 Å and a lithium layer coated on the substrate and a positive electrode comprising at least one positive active material selected from the group consisting of a lithium-included metal oxide, a lithium-included chalcogenide compound, a sulfur-based material, and a conductive polymer.

The lithium-included metal oxide or lithium-included chalcogenide compound is preferably selected from the group consisting of compounds represented by the formulas (1) to (13):

| | |
|---|---|
| LiₓMn_{1 - y}M_{y}A₂ | (1) |
| LiₓMn_{1 - y}M_{y}O_{2 - z}X_{z} | (2) |
| LiₓMn₂O_{4 - z}X_{z} | (3) |
| LiₓMn_{2 - y}M_{y}A₄ | (4) |
| LiₓCo_{1 - y}M_{y}A₂ | (5) |
| LiₓCo_{1 - y} O_{2 - z}X_{z} | (6) |
| LiₓNi_{1 - y}M_{y}A₂ | (7) |
| LiₓNi_{1 - y} O_{2 - z}X_{z} | (8) |
| LiₓNi_{1 - y}Co_{y}O_{2 - z}X_{z} | (9) |
| LiₓNi_{1 - y - z}Co_{y}M_{z}A_{α} | (10) |
| LiₓNi_{1 - y - z}Co_{y}M_{z}O _{2 - α}X_{α} | (11) |
| LiₓNi_{1 - y - z}Mn_{y}M_{z}A_{α} | (12) |
| LiₓNi_{1 - y - z}Mn_{y}M_{z}O_{2 - α}X_{α} | (13) |

wherein
0.9 ≦ x ≦ 1.1, 0 ≦ y ≦ 0.5, 0 ≦ z ≦ 0.5, 0 ≦ α ≦ 2;

M is at least one selected from the group consisting of Al, Ni, Co, Mn, Cr, Fe, Mg, Sr, V, and rare earth elements;

A is selected from the group consisting of O, F, S, and P; and

X is selected from the group consisting of F, S, and P.

The sulfur-based material is selected from the group consisting of elemental sulfur, Li₂Sₙ(n≧1), Li₂Sₙ(n≧1) dissolved in a catholyte, an organo sulfur compound, and a carbon-sulfur polymer (C₂Sₓ)ₙ (wherein x=2.5 to 50, n≧2).

A separator may further be interposed between the positive electrode and the negative electrode. The separator may be one or more layers of a compound selected from the group consisting of polyethylene, polypropylene, and polyvinylidene fluoride, or it may be a combined multi-layer such as a polyethylene/polypropylene two-layered separator, a polyethylene/polypropylene/polyethylene three-layered separator, or a polypropylene/polyethylene/polypropylene three-layered separator.

The electrolyte may include a non-aqueous electrolyte or a solid electrolyte. The non-aqueous electrolyte is prepared by dissolving a lithium salt in an organic solvent. The non-aqueous organic solvent may include a carbonate, ester, ether, or ketone. The carbonate may include dimethyl carbonate (DMC), diethyl carbonate (DEC), dipropyl carbonate (DPC), methyl propyl carbonate (MPC), ethyl propyl carbonate (EPC), methyl ethyl carbonate (MEC), ethylene carbonate (EC), propylene carbonate (PC), and butylene carbonate (BC). The ester may include n-methyl acetate, n-ethyl acetate, and n-propyl acetate. The ether may include dimethyl ether (DME) and tetrahydrofuran (THF).

The lithium salt is one or a mixture of two or more selected from the group consisting of LiPF₆, LiBF₄, LiSbF₆, LiAsF₆, LiClO₄, LiCF₃SO₃, Li(CF₃SO₂)₂N, LiC₄F₉SO₃, LiAlO₄, LiAlCl₄, LiN(CₓF₂ₓ₊₁SO₂)(C_{y}F_{2y+1}SO₂) (wherein x and y are natural numbers), LiCl, and Lil.

The solid electrolyte may include a polymer electrolyte of polyethylene oxide or a polymer electrolyte composed of at least one polyorganosiloxane side chain or polyoxyalkylene side chain; a sulfide electrolyte such as Li₂S—SiS₂, Li₂S—GeS₂, Li₂S—P₂S₅, Li₂S—B₂S₃, and the like; and an inorganic compound electrolyte such as Li₂S—SiS₂—Li₃PO₄, Li₂S—SiS₂—Li₃SO₄, and the like.

The following examples illustrate the present invention in further detail, but the present invention is not limited by these examples.

### EXAMPLE 1

The 25 μm thick copper foil was provided as a negative electrode substrate. The mean surface roughness (Ra) was determined to be 1400 Å (0.14 μm) using an optical 3D profiling system (NT2000, available from WYKO). The copper foil was covered with a stainless mask having a 1.2 cm square hole, and lithium metal was deposited thereon at a thickness of 1.5 μm. The copper foil deposited with lithium was used as a negative electrode, and lithium foil was used as a counterpart electrode to fabricate a test cell. The electrolyte used for fabricating the cell was a 1 M LiSO₃CF₃ electrolyte solution of dioxolan/diglyme/sulfolane/dimethoxy ethane (5/2/1/2 volume ratio).

### EXAMPLE 2

For a negative electrode substrate, copper was deposited on a poly(ethylene terephthalate) (PET) film. Specifically, copper was deposited on a 200 μm thick PET film using a Tungsten boat under 2×10⁻⁶ torr to prepare a negative electrode substrate. The thickness of the deposited copper was 0.1 μm, and the mean surface roughness was 100 Å (0.01 μm), determined using an optical 3D profiling system (NT2000, available from WYKO). The negative electrode substrate was covered with a stainless steel mask having a 1.2 cm square hole, and lithium metal was deposited thereon at a thickness of 1.5 μm. The lithium-deposited substrate was used as a negative electrode, and lithium foil was used as a counterpart electrode to fabricate a test cell. The electrolyte used for fabricating the cell was a 1 M LiSO₃CF₃ electrolyte solution of dioxolan/diglyme/sulfolane/dimethoxy ethane (5/2/1/2 volume ratio).

### COMPARATIVE EXAMPLE 1

A test cell was fabricated by the same procedure as in Example 1, except that the negative electrode substrate was a copper foil with a mean surface roughness of 4500 Å (0.45 μm).

Test cells according to Examples 1 and 2 and Comparative Example 1 were subjected to charge and discharge at a constant current with a current density of 1 mA/μm for 360 seconds, and the cycle efficiencies of the cells were measured. The results are shown in following Table 1:

TABLE 1

| | | | Comparative |
|---|---|---|---|
| | Example 1 | Example 2 | Example 1 |
| Cycle efficiency | 70.3% | 80.7% | 50.5% |
| (%) | | | |

As shown in Table 1, the cells using negative electrodes according to Examples 1 and 2 were superior to the cells of Comparative Example 1 in terms of cycle efficiency, since the mean surface roughness of the negative electrode substrates according to Examples 1 and 2 were within the range according to an embodiment the present invention. In particular, the lower mean surface roughness is superior in terms of cycle efficiency.

### EXAMPLE 3

For a negative electrode substrate, copper was deposited on a poly(ethylene terephthalate) (PET) film. Specifically, copper was deposited on a 200 μm thick PET film using a Tungsten boat under 2×10⁻⁶ torr to prepare a negative electrode substrate. The thickness of the deposited copper was 0.1 μm, and the mean surface roughness was 100 Å (0.01 μm), determined using an optical 3D profiling system (NT2000, available from WYKO). The negative electrode substrate was covered with a stainless steel mask having a 1.2 cm square hole, and lithium metal was deposited thereon at a thickness of 1.5 μm to prepare a negative electrode.

A positive active material of sulfur powder, a binder of polyethylene oxide (PEO), and a conductive agent of ketjen black were used at a ratio of 75, 12, and 13 wt %, respectively, to prepare a positive electrode. A separator was prepared using a 16 μm-thick, three-layered porous polymer film of polypropylene (PP)/polyethylene (PE)/polypropylene (PP). A test cell was assembled using the negative electrode, the positive electrode, and the separator. The electrolyte used for fabricating the cell was a 1 M LiSO₃CF₃ electrolyte solution of dimethoxy ethane/diglyme/dioxolan (4:4:2 volume ratio).

### COMPARATIVE EXAMPLE 2

A negative electrode was prepared by depositing lithium on a 10 μm thick copper foil having a mean surface roughness of 4470 Å (0.447 μm), determined using an optical 3D profiling system (NT2000, available from WYKO), to a thickness of 20 μm. The deposition process was carried out using a Tungsten boat at a deposition pressure of 2.0×1 0⁻⁶ torr. A test cell was fabricated by the same procedure as in Example 3 using the obtained negative electrode.

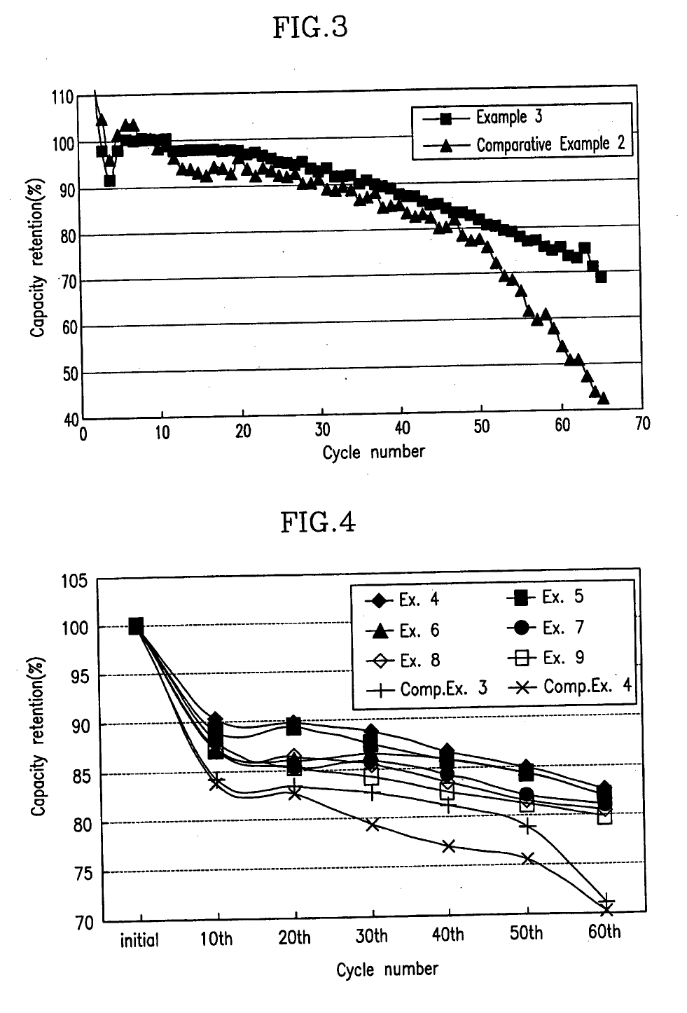

To confirm the influence of the negative electrode substrate on the cycle-life characteristics, test cells according to Example 3 and Comparative Example 2 were charged at 0.2 C and discharged at 0.5 C under a voltage range of between 1.5 and 2.8 V to determine the cycle-life characteristics, and the results are shown in FIG. 3. As shown in FIG. 3, the cycle-life characteristics of the test cell according to Example 3 with the lithium negative electrode comprising the substrate having a mean surface roughness of 100 Å is dramatically superior to the cycle-life characteristics of Comparative Example 2 comprising the substrate having a mean surface roughness of 4470 Å.

### EXAMPLES 4-9 AND COMPARATIVE EXAMPLES 3 AND 4

To evaluate battery performance with respect to the mean surface roughness of a substrate, 200 μm thick copper plates with mean surface roughness values of 450 Å (Example 4), 1078 Å (Example 5), 1424 Å (Example 6), 2000 Å (Example 7), 2473 Å (Example 8), 3200 Å (Example 9), 4537 Å (Comparative Example 3), and 5520 Å (Comparative Example 4) were used. Lithium metal was deposited on the copper plates having the controlled mean surface roughness values to a thickness of 20 μm to prepare negative electrodes. The deposition process was carried out using a Tungsten boat at a deposition pressure of 2×10⁻⁶ torr. Using the obtained negative electrodes, test cells were assembled by the same procedure as in Example 3. The capacity retention rate ((retention capacity/initial capacity)×100) was calculated for each cell, and the results are shown in Table 2.

TABLE 2

| | | Retention | Retention | Retention | Retention | Retention | Retention |
|---|---|---|---|---|---|---|---|
| | | rate (%) at | rate (%) at | rate (%) at | rate (%) at | rate (%) at | rate (%) at |
| | | 10^{th} cycle | 20^{th} cycle | 30^{th} cycle | 40^{th} cycle | 50^{th} cycle | 60^{th} cycle |
| Example 4 | 450 Å | 90.3 | 89.7 | 88.7 | 86.6 | 84.9 | 82.6 |
| Example 5 | 1078 Å | 89.0 | 89.4 | 87.6 | 85.8 | 84.3 | 82.0 |
| Example 6 | 1424 Å | 87.4 | 86.1 | 86.6 | 85.7 | 84.3 | 81.8 |
| Example 7 | 2000 Å | 88.2 | 85.3 | 85.8 | 84.3 | 82.9 | 81.0 |
| Example 8 | 2473 Å | 87.1 | 86.4 | 85.5 | 83.6 | 82.5 | 80.5 |
| Example 9 | 3200 Å | 87.2 | 85.3 | 84.2 | 82.5 | 82.2 | 79.8 |
| Comparative | 4537 Å | 84.2 | 83.4 | 82.6 | 81.1 | 77.5 | 71.1 |
| Example 3 | | | | | | | |
| Comparative | 5520 Å | 83.7 | 82.6 | 79.3 | 76.9 | 75.5 | 70.3 |
| Example 4 | | | | | | | |

The results of Table 2 are illustrated in FIG. 4. As shown in Table 2 and FIG. 4, the cycle-life characteristics of Examples 4-9, in which the mean surface roughness values are within the range according to an embodiment of the present invention, are superior to the cycle-life characteristics of Comparative Examples 3 and 4.

Since the negative electrode for the lithium secondary battery according to an embodiment of the present invention comprises a substrate having a mean surface roughness within a certain range, the cycle-life characteristics of the lithium secondary battery are improved.

While the present invention has been described in detail with reference to the preferred embodiments, those skilled in the art will appreciate that various modifications and substitutions can be made thereto without departing from the spirit and scope of the present invention as set forth in the appended claims.

Although a few preferred embodiments of the present invention have been shown and described, it would be appreciated by those skilled in the art that changes may be made in these embodiments without departing from the principles and spirit of the invention, the scope of which is define in the claims and their equivalents.

What is claimed is:

1. A negative electrode for a lithium secondary battery comprising:
a substrate having a mean roughness of 30 to 4000 Å; and
a lithium layer coated on the substrate.

2. The negative electrode for the lithium secondary battery according to claim 1, wherein the mean roughness of the substrate is 30 to 3000 Å.

3. The negative electrode for the lithium secondary battery according to claim 2, wherein the mean roughness of the substrate is 30 to 1500 Å.

4. The negative electrode for the lithium secondary battery according to claim 3, wherein the mean roughness of the substrate is 30 to 500 Å.

5. The negative electrode for the lithium secondary battery according to claim 4, wherein the mean roughness of the substrate is 30 to 100 Å.

6. The negative electrode for the lithium secondary battery according to claim 1, wherein the substrate for the negative electrode consists of a conductive material.

7. The negative electrode for the lithium secondary battery according to claim 1, wherein the substrate is selected from the group consisting of a metal foil, a metal film, a conductive polymer film, a polymer film deposited with metal, and a polymer film incorporated with a conductive agent.

8. The negative electrode for the lithium secondary battery according to claim 7, wherein the metal is copper or nickel.

9. The negative electrode for the lithium secondary battery according to claim 7, wherein the conductive polymer film is at least one selected from the group consisting of polyacetylene, polypyrrole, polyaniline, polythiophene, poly(p-phenylene), poly(phenylene vinylene), polyazulene, polyperinaphthalene, polyacene, and polynaphthalene-2,6-diyl.

10. The negative electrode for the lithium secondary battery according to claim 7, wherein the polymer film deposited with metal is a polymer film on which a metal is deposited, and wherein the polymer film is at least one selected from the group consisting of polyester, polyolefin, polyamide, polycarbonate, polyacrylate, and a copolymer or a mixture thereof.

11. The negative electrode for the lithium secondary battery according to claim 7, wherein the polymer film incorporated with the conductive agent is a polymer film having a conductive agent dispersed therein, and wherein the polymer film is at least one selected from the group consisting of polyester, polyolefin, polyamide, polycarbonate, polyacrylate, and a copolymer or a mixture thereof.

12. The negative electrode for the lithium secondary battery according to claim 11, wherein the conductive agent is selected from the group consisting of a conductive metal oxide, a metal, and a carbonaceous material.

13. The negative electrode for the lithium secondary battery according to claim 12, wherein the conductive agent is selected from the group consisting of tin oxide, tin phosphate (SnPO₄), titanium oxide, a perovskite material, tin, copper, nickel, graphite, and carbon black.

14. The negative electrode for the lithium secondary battery according to claim 7, wherein the mean roughness of polymer film deposited with metal is 30 to 3500 Å.

15. The negative electrode for the lithium secondary battery according to claim 14, wherein the mean roughness of polymer film deposited with metal is 30 to 3000 Å.

16. The negative electrode for the lithium secondary battery according to claim 15, wherein the mean roughness of the polymer film deposited with metal is 30 to 1500 Å.

17. The negative electrode for the lithium secondary battery according to claim 16, wherein the mean roughness of the polymer film deposited with metal is 30 to 500 Å.

18. The negative electrode for the lithium secondary battery according to claim 17, wherein the mean roughness of the polymer film deposited with metal is 30 to 100 Å.

19. The negative electrode for the lithium secondary battery according to claim 1, wherein the lithium layer is prepared by depositing lithium on the substrate or by compressing a lithium foil thereon.

20. A lithium secondary battery comprising
a negative electrode according to claim 1; and
a positive electrode comprising at least one positive active material selected from the group consisting of a lithium-included metal oxide, a lithium-included chalcogenide compound, a sulfur-based material, and a conductive polymer.

21. The lithium secondary battery according to claim 20, wherein the lithium-included metal oxide or lithium-included chalcogenide compound is at least one selected from the group consisting of compounds represented by the formulas (1) to (13):

| | |
|---|---|
| LiₓMn_{1 - y}M_{y}A₂ | (1) |
| LiₓMn_{1 - y}M_{y}O_{2 - z}X_{z} | (2) |
| LiₓMn₂O_{4 - z}X_{z} | (3) |
| LiₓMn_{2 - y}M_{y}A₄ | (4) |
| LiₓCo_{1 - y}M_{y}A₂ | (5) |
| LiₓCo_{1 - y} O_{2 - z}X_{z} | (6) |
| LiₓNi_{1 - y}M_{y}A₂ | (7) |
| LiₓNi_{1 - y} O_{2 - z}X_{z} | (8) |
| LiₓNi_{1 - y}Co_{y}O_{2 - z}X_{z} | (9) |
| LiₓNi_{1 - y - z}Co_{y}M_{z}A_{α} | (10) |
| LiₓNi_{1 - y - z}Co_{y}M_{z}O _{2 - α}X_{α} | (11) |
| LiₓNi_{1 - y - z}Mn_{y}M_{z}A_{α} | (12) |
| LiₓNi_{1 - y - z}Mn_{y}M_{z}O_{2 - α}X_{α} | (13) |

wherein
0.9 ≦ x ≦ 1.1, 0 ≦ y ≦ 0.5, 0 ≦ z ≦ 0.5, 0 ≦ α ≦ 2;
M is at least one selected from the group consisting of Al, Ni, Co, Mn, Cr, Fe, Mg, Sr, V, and rare earth elements;
A is selected from the group consisting of O, F, S, and P; and
X is selected from the group consisting of F, S, and P.

22. The lithium secondary battery according to claim 20, wherein the sulfur based material is selected from the group consisting of elemental sulfur, Li₂Sₙ(n≧1), or Li₂Sₙ(n≧1) dissolved in a catholyte, an organo sulfur compound, and a carbon-sulfur polymer (C₂Sₓ)ₙ (wherein x=2.5 to 50, n≧2).

23. The lithium secondary battery according to claim 20, further comprising a separator interposed between the positive electrode and the negative electrode, wherein the separator is selected from the group consisting of a polyethylene, polypropylene, or polyvinylidene fluoride separator, a polyethylene/polypropylene two-layered separator, a polyethylene/polypropylene/polyethylene three-layered separator, and a polypropylene/polyethylene/polypropylene three-layered separator.

24. The lithium secondary battery according to claim 20, further comprising an electrolyte, wherein the electrolyte is a non-aqueous electrolyte or a solid electrolyte.

25. The lithium secondary battery according to claim 20, wherein the negative electrode comprises:
a substrate having a mean roughness of 30 to 4000 Å; and
a lithium layer coated on the substrate.

26. The lithium secondary battery according to claim 25, wherein the mean roughness of the substrate is 30 to 1500 Å.

27. The lithium secondary battery according to claim 26, wherein the mean roughness of the substrate is 30 to 500 Å.

28. The lithium secondary battery according to claim 27, wherein the mean roughness of the substrate is 30 to 100 Å.

29. The lithium secondary battery according to claim 25, wherein the substrate for the negative electrode consists of a conductive material.

30. The lithium secondary battery according to claim 25, wherein the substrate is selected from the group consisting of a metal foil, a metal film, a conductive polymer film, a polymer film deposited with metal, and a polymer film incorporated with a conductive agent.

31. The lithium secondary battery according to claim 30, wherein the metal is copper or nickel.

32. The lithium secondary battery according to claim 30, wherein the conductive polymer film is at least one selected from the group consisting of polyacetylene, polypyrrole, polyaniline, polythiophene, poly(p-phenylene), poly(phenylene vinylene), polyazulene, polyperinaphthalene, polyacene, and polynaphthalene-2,6-diyl.

33. The lithium secondary battery according to claim 30, wherein the polymer film deposited with metal is a polymer film on which a metal is deposited, and wherein the polymer film is at least one selected from the group consisting of polyester, polyolefin, polyamide, poly(vinylidene fluoride), poly(tetrafluoro ethylene), polystyrene, poly(acrylonitrile), poly(vinyl chloride), polycarbonate, polyacrylate, and a copolymer or a mixture thereof.

34. The lithium secondary battery according to claim 30, wherein the polymer film incorporated with the conductive agent is a polymer film having a conductive agent dispersed therein, and wherein the polymer film is at least one selected from the group consisting of polyester, polyolefin, polyamide, poly(vinylidene fluoride), poly(tetrafluoro ethylene), polystyrene, poly(acrylonitrile), poly(vinyl chloride), polycarbonate, polyacrylate, and a copolymer or a mixture thereof.

35. The lithium secondary battery according to claim 34, wherein the conductive agent is selected from the group consisting of a conductive metal oxide, a metal, and a carbonaceous material.

36. The lithium secondary battery according to claim 35, wherein the conductive agent is selected from the group consisting of tin oxide, tin phosphate (SnPO₄), titanium oxide, a perovskite material, tin, copper, nickel, graphite, and carbon black.

37. The lithium secondary battery according to claim 33, wherein the mean roughness of polymer film deposited with metal is 30 to 3000 Å.

38. The lithium secondary battery according to claim 37, wherein the mean roughness of the polymer film deposited with metal is 30 to 1500 Å.

39. The lithium secondary battery according to claim 38, wherein the mean roughness of the polymer film deposited with metal is 30 to 500 Å.

40. The lithium secondary battery according to claim 39, wherein the mean roughness of the polymer film deposited with metal is 30 to 100 Å.

41. The lithium secondary battery according to claim 25, wherein the lithium layer is prepared by depositing lithium on the substrate or by compressing a lithium foil thereon.

42. The negative electrode of claim 11, wherein the polyester is one of: poly(ethylene terephthalate) (PET), poly(butylene terephthalate) (PBT), a copolymer thereof and a mixture thereof.

43. The negative electrode of claim 11, wherein the polyolefin is one of: polyethylene, polypropylene, a copolymer thereof and a mixture thereof.

44. The negative electrode of claim 11, wherein the polyamide is one of: nylon, a copolymer thereof and a mixture thereof

45. The negative electrode according to claim 7, wherein the polymer film deposited with metal is a polymer film on which a metal is deposited, and wherein the polymer film is at least one selected from the group consisting of: poly(vinylidene fluoride), poly(tetrafluoro ethylene), polystyrene, poly(acrylonitrile), poly(vinyl chloride), a copolymer thereof and a mixture thereof.

46. The negative electrode of claim 11, wherein the polyacrylate is one of:
poly(methyl methacrylate), and a copolymer or a mixture thereof.

47. The negative electrode of claim 10, wherein the polyester is one of: poly(ethylene terephthalate) (PET), poly(butylene terephthalate) (PBT), a copolymer thereof and a mixture thereof.

48. The negative electrode of claim 10, wherein the polyolefin is one of:
polyethylene, polypropylene, a copolymer thereof and a mixture thereof.

49. The negative electrode of claim 10, wherein the polyamide is one of: nylon, a copolymer thereof and a mixture thereof

50. The negative electrode for the lithium secondary battery according to claim 7, wherein the polymer film incorporated with the conductive agent is a polymer film having a conductive agent dispersed therein, and wherein the polymer film is at least one selected from the group consisting of: poly(vinylidene fluoride), poly(tetrafluoro ethylene), polystyrene, poly(acrylonitrile), poly(vinyl chloride), a copolymer thereof and a mixture thereof.

51. The negative electrode of claim 10, wherein the polyacrylate is one of:
poly(methyl methacrylate), and a copolymer or a mixture thereof.

52. A negative electrode for a lithium secondary battery comprising:
a polymer film deposited with metal; and
a lithium layer coated on the polymer film.

53. The negative electrode according to claim 52, wherein the mean roughness of the substrate is 30 to 3000 Å.

54. The negative electrode according to claim 53, wherein the mean roughness of the substrate is 30 to 1500 Å.

55. The negative electrode according to claim 54, wherein the mean roughness of the substrate is 30 to 500 Å.

56. The negative electrode according to claim 55, wherein the mean roughness of the substrate is 30 to 100 Å.

57. The negative electrode according to claim 52, wherein the polymer film deposited with metal is a polymer film on which a metal is deposited, and wherein the polymer film is at least one selected from the group consisting of polyester, polyolefin, polyamide, polycarbonate, polyacrylate, and a copolymer or a mixture thereof.

58. The negative electrode of claim 57, wherein the polyester is one of: poly(ethylene terephthalate) (PET), poly(butylene terephthalate) (PBT), a copolymer thereof and a mixture thereof.

59. The negative electrode of claim 57, wherein the polyolefin is one of: polyethylene, polypropylene, a copolymer thereof and a mixture thereof.

60. The negative electrode of claim 57, wherein the polyamide is one of: nylon, a copolymer thereof and a mixture thereof

61. The negative electrode according to claim 52, wherein the polymer film deposited with metal is a polymer film on which a metal is deposited, and wherein the polymer film is at least one selected from the group consisting of: poly(vinylidene fluoride), poly(tetrafluoro ethylene), polystyrene, poly(acrylonitrile), poly(vinyl chloride), a copolymer thereof and a mixture thereof.

62. The negative electrode of claim 57, wherein the polyacrylate is one of: poly(methyl methacrylate), and a copolymer or a mixture thereof.
